(19) United States
(12) Patent Application Publication
(10) Pub. No.: US 2007/0091030 A1
(43) Pub. Date: Apr. 26, 2007

(54) Electronic control cell for an active matrix display organic electroluminescent diode and methods for the operation thereof and display

(75) Inventors: Bernard Drevillon, Clamart (FR); Francois Camille Anceau, Plaisir (FR); Yvan Eric Bonnassieux, Paris (FR); Regis Vanderhaghen, Palaiseau (FR)

Correspondence Address: YOUNG & THOMPSON, 745 SOUTH 23RD STREET, 2ND FLOOR, ARLINGTON, VA, 22202, US

(73) Assignees: CENTRE NATIONAL DE LA RECHERCHE SCIENTIFIQUE, PARIS CEDEX (FR); ECOLE POLYTECHNIQUE, PALAISEAU CEDEX (FR)

(21) Appl. No.: 10/582,493

(22) PCT Filed: Dec. 13, 2004
(86) PCT No.: PCT/FR04/50685

§ 371 Date: Jun. 12, 2006

(30) Foreign Application Priority Data
Dec. 11, 2003 (FR) 0351026

(51) Int. Cl. G09G 3/30

(52) U.S. Cl. 345/76

(57) ABSTRACT

An electronic control cell for at least one organic light-emitting diode (OLED) of a pixel or segment of an active matrix display, the cell including at least one control circuit (6,61,62) with a control input and operating relative to a control signal arriving at a control line (5,5′) and enabling to turn the OLED(s) on, one capacitive storage circuit of the control signal with a capacitor C connected to the control line, one selection circuit (4,41,42) operating relative to a selection signal Vₛₑₗ on a selection line (3,3′) and enabling electrical connection or insulation of the capacitive storage circuit with/from a control voltage V_{com} (2) relative to the selection signal. The storage is temporary by discharging the capacitor through a resistor Rf parallel to the capacitor. Operating methods and a display unit are also disclosed.

The present invention relates to an electronic control cell for organic light-emitting diode of active matrix display as well as operating methods. It finds applications in the domain of the display units, notably flat screens, whereof elementary display units, pixels or segments, with organic light-emitting diodes are controlled individually by control cells arranged in the form of one or several matrices.

The development of electronic equipment and/or industrial data processing equipment or mass public equipment requires the use of interfaces of interaction with the users and notably of visual interfaces with display units or segment or pixel monitors, these four terms being considered two by two in an equivalent fashion below. In order to provide enhanced display features, it is preferred currently to act individually on the display elementary units (segments or pixels) and it is thus that the display units with active matrix have been developed.

On top of a possible cost reduction, miniaturising and searching for increased stand-alone capacity have led to implementing technologies enabling to reduce the space requirements of the display units and to lower the power consumption as with liquid crystals. However, the latter technology exhibits a few limitations and shortcomings whereof a relative complexity due to the fact that the display is indirect inasmuch as polarization conditions of an external lighting should be acted upon. Other technologies based on a direct display, i.e. wherein the elementary units produce light, have been therefore developed and in particular that relative to the light-emitting diodes whereof a specific domain is considered more particularly here, that of the organic light-emitting diodes or OLED which enable to provide display units on various substrates such as glass or plastic materials and under interesting manufacturing conditions.

In the known OLED display units with active matrix, the control of each diode or of a group of light-emitting diodes of a pixel or segment is conducted in current which enables to obtain a linear control law between the log of the intensity I_{d} running through the diode and the log of the luminosity Lum, i.e. log(Lum)=A*log(I_{d}). However, the control circuit associated with a pixel is generally complex and requires control transistors which may sustain relatively high currents. The purpose of this control circuit is to maintain the control and the extinction of the OLED(s) of the pixel by, at an appropriate instant, an additional control signal, of the same type as that used for switching on or selecting the pixel and, generally, by a short ignition control pulse in one case and an extinction pulse in the other.

The major defect of such a control in current, results from the fact that it is generally realised by a complex assembly of at least four transistors, so-called in “current mirror”. This involves passing a high current through all the transistors of the pixel as well as in the control circuits situated upstream, and this, throughout a control cycle. Besides the fact that two control lines are necessary for operating the current mirror, these high currents should circulate via control lines provided on the display unit with relatively significant ohmic losses. This creates naturally constraints in terms of size and regarding the electronic mobility of these transistors, which leads, on top of the difficulties of realisation, to high energy consumption of the monitor.

In the matrix display units, the control of each of the pixels is multiplexed on a line×column basis and the display of a frame is carried out on a line×line basis (or a column×column basis according to the embodiment selected). Moreover, since the pixel remains turned on with substantially constant luminous level throughout the duration of a frame causes the transition of a light level from one frame to the other may be sudden. Such transitions may for example take place because an object displayed in a scene moves in the scene with the course of time, Still, such sudden transitions are perceived by the eye and disturb the visual perception of the scene animated on the screen. This causes a blurring effect which may be rather unpleasant.

The invention offers to solve these difficulties while providing a pixel control in voltage which enables additionally to simplify the control circuit associated with each pixel or segment. It uses the memory effect of an additional or intrinsic capacitor being discharged in an additional or intrinsic resistor of an electronic current switch of the OLED(s) of the pixel. The implementation of a voltage-based control enables additionally to limit the constraints on the size of the transistors and the electronic mobility (load carriers). It is thus possible to realise such display units with thin-film transistors, so-called TFT, with small mobility or not and, for example in amorphous or micro-crystalline or poly-crystalline silicon, possibly even organic transistors.

The invention relates to therefore an electronic control cell for at least one organic light-emitting diode (OLED) of a pixel or segment of an active matrix display, the cell including at least:
one control circuit with a control input and operating as an electronic switch relative to a control signal arriving at a control line on the control input and enabling to turn on the OLED(s) or not, relative to said control signal,
one capacitive storage circuit of the control signal with a capacitor C connected to the control line,
one selection circuit operating as an electronic switch relative to a selection signal Vₛₑₗ arriving at a selection line and enabling electrical connection or insulation of the capacitive storage circuit with/from a control voltage V_{com} relative to said selection signal.

According to the invention, the storage is temporary by discharging the capacitor through a resistor Rf parallel to the capacitor.

In diverse embodiments of the invention, the following means which may be combined according to all the technical possibilities, are employed:
the control signal is modulated in duration and/or in level of voltage; (enables to vary the time during which the OLED(s) of the pixel are turned on relative to the needs)
the control voltage V_{com} is modulated in level of voltage;
the selection signal Vₛₑₗ is modulated in duration;
the display is periodic by frames and the values of C and Rf have been chosen so that under average operating conditions the storage duration of a turned-on state is smaller than the duration of a frame,
preferably the duration of storage is smaller than or equal to half the duration of a frame,
the capacitor C is substantially an added-on capacitor,
the capacitor C is substantially the capacitive portion of the intrinsic input impedance of the control circuit,
the resistor Rf is substantially an added-on resistor,
the added-on resistor Rf is realised from a transistor mounted as a resistive circuit,
the resistor Rf is substantially the resistive portion of the intrinsic input impedance of the control circuit,
the resistor Rf is substantially a leakage resistor of the capacitor, (the capacitor is not perfect and exhibits a leakage current and preferably according to substantially ohmic law)
the cell includes a means reducing the maximum rise and/or fall rate of the voltage at the terminals of the capacitor C when the latter is connected to the control voltage V_{com},
the control circuit is a field effect control transistor M1,
the control transistor M1 is with a single gate,
the control transistor M1 is with a double gate,
the selection circuit is a field effect control transistor M2,
the selection transistor M2 is with a single gate,
the selection transistor M2 is with a double gate,
the control circuit is a P-type field effect control transistor M1 connected on the one hand directly to the positive pole Vₚₚ of the power supply and on the other hand through the OLED(s) to the ground of the power supply, the selection circuit is a P-type field effect control transistor M2 and the capacitor C and the resistor Rf in parallel return to the positive pole Vₚₚ,
the control circuit is a N-type field effect control transistor M1 connected on the one hand directly to the ground of the power supply and on the other hand through the OLED(s) to the positive pole Vₚₚ of the power supply, the selection circuit is a N-type field effect control transistor M2 and the capacitor C and the resistor Rf in parallel return to the ground,
the transistors are thin-film transistors, so-called TFT,
the transistors are made of amorphous or micro-crystalline or poly-crystalline silicon, possibly even organic transistors.

The invention also relates to an operating method of an electronic control cell for at least one organic light-emitting diode (OLED) of a pixel or segment of an active matrix display, the cell having at least:
one control circuit with a control input and operating as an electronic switch relative to a control signal arriving at a control line on the control input and enabling to turn on the OLED(s) or not, relative to said control signal,
one capacitive storage circuit of the control signal with a capacitor C connected to the control line,
one selection circuit operating as an electronic switch relative to a selection signal Vₛₑₗ arriving at a selection line and enabling electrical connection or insulation of the capacitive storage circuit with/from a control voltage V_{com} relative to said selection signal.

According to the method, there is implemented a cell which is according to the one or several previous features and wherein the discharge of the capacitor is caused through a resistor Rf arranged parallel to the capacitor in order to provide a temporary storage of a turned-on state, and wherein, under average operating conditions the storage duration of a turned-on state is smaller than the duration of a frame, and preferably smaller than or equal to half the duration of a frame.

In a variation of the method, for turning the OLED(s) on a selection pulse Vₛₑₗ is applied to the selection line of such a duration that at the end of the selection pulse the voltage at the terminals of the capacitor is a fraction of V_{com}. In other variations which may be combined with the latter:
the control signal is modulated in duration and/or in level of voltage (notably from one frame to another);
the control voltage V_{com} is modulated in level of voltage;
the selection signal Vₛₑₗ is modulated in duration.

The invention relates finally to a display unit with organic light-emitting diodes (OLED) of pixels and/or segments implementing a set of electronic control cells of said diodes organised into a matrix, each pixel or segment being controllable individually by line×column multiplexing of the matrix, wherein the cells are according to one or several cell features indicated previously.

In a modality for manufacturing the display unit, the selection signals Vₛₑₗ correspond to the lines of the matrix and the control voltages V_{com} correspond to the columns of the matrix.

The invention enables the realisation of a simplified display unit and if the simplification of the electronic control cells of the pixels of the display unit may be accompanied by an increase in complexity of the driving circuits upstream of the display unit and of its cells, this enhanced complexity concerns circuits implementing well-known technologies, such as the integrated circuits built from silicon slices, and whereof the global impact in cost and/or consumption in a complete electronic or data processing piece of equipment is minimum with respect to the gain provided by the invention at the level of the display unit. It may be implemented for the realisation of flexible flat screens.

Among the advantages of the invention in the case of using a control transistor, one may quote the suppression of the blurring effect which is conversely observed on the display units of the state of the art. This is due to the fact that the voltage at the terminals of the capacitor decreases gradually with time, which reduces the light intensity of the OLED down to the threshold of the control transistor where, from that moment on, the control transistor is not conductive any longer and does not supply the OLED any longer. There is not any sudden transition any longer from a constant level to another constant luminosity level, from one frame to the next. One may also modify the display luminosity relative to the load sent to the capacitor during the selection of the cell of the pixel, a load which depends on the voltage V_{com} (and/or Vₛₑₗ). The current circulating through the OLED(s) and the light-up duration depend on V_{com} (and/or Vₛₑₗ). Moreover, the capacitor being discharged at the time when the cell of the pixel is accessed for displaying the following frame, there is no significant memory effect at the level of luminosity from one frame to the next.

The invention enables to obtain additionally structural simplification of the display unit, enhanced display features in terms of reduced consumption and, possibly as explained herein, reduced visual perception.

Indeed, among the other advantages of the invention, one may also quote the fact that refreshing the display of each diode OLED may enable to modulate, notably in all or in part, the light energy produced with times at high frequencies (pulsed rate) not enabling conscientious perception of the modulation by the human user, but which provides however enhanced perception with respect to a display which would be continuous. Besides, such a modulation enables to use in each diode OLED discontinuous (pulsed) currents which may be vastly greater than the currents that each diode may accept continuously, hence a possibility of increasing still further the perception by the user.

The present invention will now be exemplified by the following description, without being limited thereto, and in relation with:

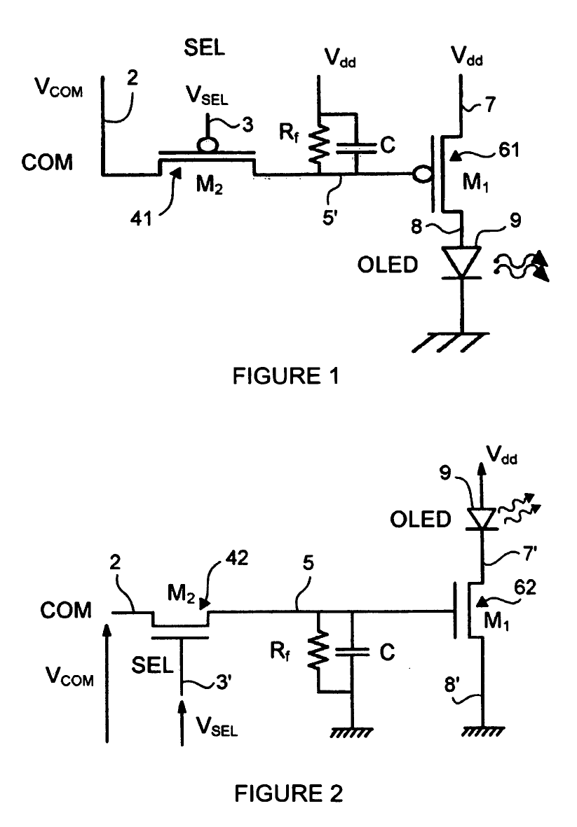

FIG. 1 which represents a first example for manufacturing the control cell,

FIG. 2 which represents a second example for manufacturing the control cell,

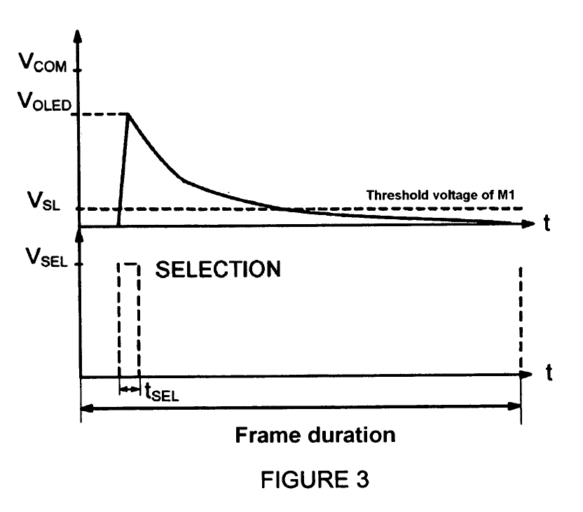

FIG. 3 which represents time evolution diagrams of the selection voltage Vₛₑₗ, of the voltage at the terminals of the capacitor and of the current in the OLED.

According to the invention in its entirety, the electronic control cell for organic light-emitting diode(s) (OLED) of a pixel/segment of an active matrix display, includes a matrix set of such cells. Such a display unit operates sequentially by time units corresponding each to the duration of display of a frame. Throughout a frame duration, the columns or lines of the matrix are scanned to enable the configuration of display (level/intensity of turning on or off) of each of the pixels/segments. The OLED(s) of the pixel/segment are supplied by means of a control circuit which operates as an electronic switch relative to a control signal arriving via a control line and enabling to circulate or not in the OLED a current of variable intensity obtained between a ground and a positive power supply terminal V_{dd}.

The leadthrough impedance (resistor) of the control circuit in the conductive state is relatively small so as to turn on the OLEDs and to avoid ohmic dissipation (Joule effect) and excessive losses. In locked, non conductive, state the control circuit exhibits high leadthrough impedance (resistor), such that the leakage current is negligible and does not turn on the OLEDs.

In a preferred embodiment, the control circuit exhibits high control input impedance and hardly stresses the control line which includes a capacitor C and a resistor Rf which returns to the ground or V_{dd} according to the case. The capacitor C and the resistor Rf may be added-on and/or intrinsic elements of other elements of the cell. In the latter case, C may be the <<spurious>> input capacitor of the control circuit and/or Rf the input impedance (resistor) of the control circuit (the control circuit has not high impedance/input resistor any longer). One contemplates the case when Rf is the own leakage resistor of the capacitor (or conversely C is the spurious capacitor of the resistor Rf) which involves the manufacture of a particular capacitor (or conversely of a resistor) since the components available conventionally are generally practically pure components, i.e. resistors which are practically pure resistors and capacitors which are practically pure capacitors.

This section of the cell with the control circuit and the control line with its capacitor C and resistor Rf, forms a switching element with temporary memory: when the voltage on the control line exceeds the conduction threshold Vₛₗ of the control circuit, the latter becomes conductive and, conversely, when the voltage on the control line falls below the conduction threshold Vₛₗ of the control circuit, the latter becomes locked, non-conductive. The control circuit may operate on an all-or-nothing basis (substantially constant conductive/non-conductive) or linearly as will be seen with transistors in the case of FIGS. 1 and 2. It should be understood that this explanation is simplified since generally the control circuit may exhibit a hysteresis (<<Schmidt trigger>>) and/or exhibit gradual conduction zones as will be seen below in the case of using transistors. Moreover, the conditions of conduction or non-conduction above or below the threshold may be reversed according to the reversal type or not of the control circuit. Similarly, the evolution of the load of the capacitor after turning on the OLED and towards turning off the OLED, if it corresponds preferably to a discharge (resistor parallel to the capacitor), the case of a load of the capacitor may be contemplated by way of equivalence. In the case of a load of the capacitor, the resistor returns to the power supply terminal opposite to which the capacitor returns: the capacitor and the resistor are connected in series between both power supply terminals and the control line is connected at the middle location, between the resistor and the capacitor. In the latter loading case, it should be understood that the selection circuit must cause a discharge for lighting-up and that the lighting of the OLED(s) by the control circuit should correspond to a discharge state.

Once loaded, the capacitor C will be discharged gradually and if the initial load of C is such that the voltage on the control line is greater than the threshold Vₛₗ, the OLED(s) will remain turned on as long as the decreasing voltage on the control line will be greater than the conduction threshold Vₛₗ, of the control circuit.

To be able to load the capacitor C, a selection circuit which operates also as a switch controlled by a selection signal Vₛₑₗ, may apply (conductive state) or not (locked, insulating state) to the control line a voltage V_{com}. The voltage V_{com} may be comprised between a voltage smaller than the threshold Vₛₗ, preferably minimum 0V (at the ground) and a voltage greater than the threshold Vₛₗ, preferably maximum V_{dd}. This voltage V_{com} is one of the means for adjusting the display luminosity in the case of a transistor control circuit as represented on FIG. 1 or 2. The selection circuit behaves therefore with the capacitor C as a sample and hold but with a time constant such that during the blockage (insulation), the voltage on the control line decreases gradually. As will be seen at a later stage, it is advantageous to limit the current peak running through the selection circuit and/or the maximum load voltage of the capacitor C.

FIGS. 1 and 2 provide two particularly interesting examples of realisation since relatively simple to realise with only two transistors.

FIG. 1, the control circuit consists of a single control transistor 61, M1, connected between V_{dd} by the line 7 and OLED(s) 9 and returning to the ground via the line 8. The input of the control transistor 61 is connected to the control line 5′ whereon a capacitor C and a resistor Rf can be found, both returning to the V_{dd}. The selection circuit consists of a single selection transistor 41, M2, connected between the line 2 to the voltage V_{com} and the control line 5′. The selection transistor 41 receives at input the line 3 of selection signal Vₛₑₗ. The operating principle of this first example may be deduced from that given for the second example which is now presented.

FIG. 2, the control circuit consists of a single control transistor 62, M1, connected between V_{dd} by means of one or several OLED(s) by the line 7′ and return to the ground via the line 8′. The input of the control transistor 62 is connected to the control line 5 whereon a capacitor C and a resistor Rf can be found, both returning to the ground. The selection circuit consists of a single selection transistor 42, M2, connected between the line 2 to the voltage V_{com} and the control line 5. The selection transistor 42 receives at input the line 3′ of selection signal Vₛₑₗ. When the voltage of the control line 5 is greater than the conduction threshold of the control transistor 62, the latter is conductive and the OLED(s) are turned on. A positive selection signal Vₛₑₗ, for example equal to V_{dd}, makes the selection transistor 42 conductive and the voltage V_{com} of the line 2 is applied to the control line 5. It should be noted that according to the voltage difference between Vₛₑₗ and the line 5, the selection voltage transistor 42 can be made conductive or not, whereas the difference should be greater than the conduction threshold of the selection transistor M2 to make it conductive. If systematic switching is requested (selection transistor conductive, producing) regardless of the voltage (residual) on the control line 5, that Vₛₑₗ should be as high as possible during the selection (selection pulse) and, for example, at V_{dd}. One may notice that it is also possible of using M2 as a switch with a load equaliser and chopping effect because the voltage difference should be greater than the conduction threshold of M2, the voltage at the terminals of the capacitor may not be greater than the maximum voltage of Vₛₑₗ. It should be understood that during the selection pulse, if V_{com} is connected to the ground (or close to the ground), the capacitor C may be discharged and if V_{com} is positive (V_{dd} or close to), the capacitor can be charged.

It may be noted that because of the use of a transistor which exhibits at least one substantially linear operating zone 62 or 61, for the control circuit and because the voltage on the control line, 5 or 5′, varies with time, the current circulating in the OLED(s) will also vary with time and therefore the light intensity produced also up to the conduction threshold, a moment from which no more current run through the transistor and therefore through the OLED(s).

In the case of several organic light-emitting diodes operated by the control transistor, said diodes may be in series and/or in parallel. Besides, the invention can be implemented in a display unit including redundant components, notably cells and/or transistors and/or light-emitting diodes, which may be substituted for faulty components in order to reduce the production wastage of the display units which may include millions of components.

It has been seen therefore that in its easiest embodiment, the invention consists, basically, in controlling in voltage a pixel by charging a capacitor by a selection transistor M2 with a control voltage V_{com} (which is preferably held substantially constant during the charging but it can be varied from one frame to another in order to modify the luminosity of the successive pixels of a column) throughout the pulse duration of the selection signal Vₛₑₗ corresponding to the pixel. This voltage-operate control circuit behaves like a sample and hold which enables to charge a capacitor throughout the sampling period and to keep the charge (here decreasing) throughout the blockage period. This capacitor is directly connected to the gate of a switching transistor M1 which enables to feed the OLED(s) of the pixel. This gate exhibits high input impedance and the discharge of the capacitor through the gate (and the possible resistor parallel to the capacitor) is relatively slow, preferably such that the OLED(s) are supplied throughout half the duration of a frame.

This capacitor may be an added-on capacitor or the input capacitor, possibly increased by construction, of the control gate of the switching transistor M1. An added-on resistor or a leakage current of the capacitor or of the gate of the switching transistor, then causes gradual discharge of the capacitor and therefore automatic turning-off of the OLED(s) as soon as the voltage of the gate of the control transistor M1 falls below the threshold voltage Vₛₗ, of the switching transistor. This extinction takes place at the end of a duration which depends on the threshold Vₛₗ of M1, on the control voltage V_{com}, on the value of the capacitor, the value of the impedances limiting the charge and the value of the discharge impedances. According to these values and the duration of the selection (selection pulse) tₛₑₗ, the value of the maximum voltage applied to the gate varies, hence the time control effect of the OLED(s). One may therefore modify the duration of the lighting of the OLED(s) simultaneously by construction, once for all (for example with a capacitor value C determined by construction), or dynamically, in operation (for example in modifying the duration of the selection pulse tₛₑₗ and/or the value of the voltage V_{com}, possibly of the voltage Vₛₑₗ).

The operating principle of a cell as that represented on FIG. 2 is summed up on FIG. 3 with, in the lower section a temporal diagram of the selection signal throughout a frame duration and in the upper section a temporal diagram of the voltage of the control line 5 corresponding to the voltage at the terminals of the capacitor, also throughout a frame duration. Let us assume here the case of a charge of the capacitor C but that of the discharge is deduced from the following explanations. In the lower section of FIG. 3, the selection signal Vₛₑₗ runs through a positive voltage level throughout a pulse of duration tₛₑₗ which makes M2 conductive throughout said duration. In the upper section of FIG. 3, during the pulse, the capacitor is charged up to the value of voltage V_{oled} at the completion of the selection pulse (section increasing rapidly on the curve) then, as of the completion of the selection pulse, the capacitor is discharged gradually (section decreasing slowly on the curve). In the sections of the curve above the conduction threshold Vₛₗ, of the control transistor M1, the OLED(s) are turned on and, reversely, below, the OLED(s) are turned off.

One may correlate the evolution of the voltage of the control line 5 of FIG. 3 with the evolution of the current running through the OLED(s) and which varies relative to the temporal evolution of the voltage at the terminals of the capacitor and of the resistor. The control transistor operates linearly and the current follows the evolution of the voltage of the control line within the offset attributed to the existence of the threshold voltage of the transistor M1. It may be contemplated however that the transistor operates for a certain time in a saturation mode (while the capacitor is towards its loading peak) but the control of luminosity becomes more difficult.

One may therefore obtain a variation in luminosity of the pixels while modulating the control signal in duration and/or in level of voltage (initial, at the completion of the selection pulse) from one frame to another. This modulation may be obtained in several ways, according to whether the control voltage V_{com} is modulated in level of voltage and/or the selection signal Vₛₑₗ is modulated in duration, let alone the selection pulse Vₛₑₗ is modulated in level of voltage.

To have an idea of the durations of the different signals implemented, one may consider the case of a display unit including 768 lines and 1024 pixels per line and for which the frame frequency is 75 Hz, i.e. 13.3 ms. The duration of a line is then 17.6 μs, which corresponds to the width of the selection pulse Vₛₑₗ.

It may be noted that with a selection pulse of not too long a duration, the capacitor is only charged partially (discharged) during the selection pulse of the line, the maximum voltage at the terminals of the capacitor does not reach the voltage applied V_{com}. This means that the voltage at the terminals of this capacitor (i.e. the gate voltage of the control transistor M1) is not brought to the value V_{com} upon completion of this impulsion, but at a potential which is a fraction of V_{com}. It may also be contemplated that the capacitor is charged up to substantially V_{com} throughout the duration of the selection pulse Vₛₑₗ.

It is useful to limit the charge current of the capacitor through the selection transistor in order to limit the size of the selection transistor and to prevent it from being charged completely to the control voltage V_{com} with the duration tₛₑₗ of the selection pulses used since a circuit, which would ensure complete charging of the capacitor, would not exhibit many advantages with respect to a conventional control in current. This limitation of the charging current may be obtained in several ways, possibly combined, whereof five examples are given below. Firstly while increasing the internal resistance of the source V_{com} with the shortcoming of having variations in the maximum charging voltage relative to the number of cells selected in case when several cells are selected simultaneously. Secondly, using a selection transistor which exhibits a relatively high leadthrough impedance in conductive state, hence the possibility of using transistors with small mobility. Thirdly by addition of a resistor in series with the selection transistor. Fourthly, by addition of a non-linear component limiting the current peak and arranged in series with the selection transistor. Fifthly, by addition of a constant current generator in series or combined with the selection transistor.

The assemblies suggested wherein the capacitor and the control transistor have both a direct common point (Vdd for FIG. 1 and ground for FIG. 2) also enable to operate the control transistor in a stable linear/saturated state, since insensitive to the potential difference at the terminals of the OLED(s) and this, without having to adjust precisely the other power supply voltages. These assemblies oppose those not represented but also considered as falling within the framework of the invention wherein the control transistor returns to the common point by means of the OLED(s), i.e. for FIG. 1, the case when the OLED 9 were situated on the line 7 on the side V_{dd} of the control transistor 61 M1 and the line 8 returned directly to the ground. For FIG. 2, this would correspond to the case when OLED 9 were situated on the line 8′ on the ground side of the control transistor 62 M1 and the line 7′ returned directly to the V_{dd}.

It should be noted that with the invention and in the case of using transistors as represented on FIGS. 1 and 2, the intensity profile in the OLED and therefore of the light emitted by said OLED is not linearly function of the control any longer as in the case of the current-controlled pixels. The correction of the control signal, in order to compensate for this non-linearity as well as other effects, may take place in the electronic driving circuit upstream of the display unit.

The preferred operating method is the one wherein the OLEDs are turned on only throughout a section of the frame duration, i.e. there is a non-productive time during which each OLED is not turned on throughout a frame duration (it can be understood that an OLED of a pixel which should not be visible, will be turned off throughout the duration of the frame and that an OLED of a pixel which should be visible will be turned on only for a section of the duration of the frame). The non-productive time enables to place the OLED in idle mode and may have a beneficial effect on the life duration of the OLEDs. Besides, on top of the fact that a greater ridge current may be sent into an OLED which has an idle time, there might be favourable psychovisual effects with cyclic ignition of the OLEDs.

Thanks to the device and method of the invention, a voltage control enables modulation of duration of the current sent through the OLED. Indeed, for simplification purposes, the control circuit 61, 62 operates substantially in all or nothing mode, letting current through and turning on the OLED when the voltage on its control line 5, 5′ is greater than a threshold and locked beneath. Still the selection circuit 41, 42 which receives a substantially binary selection signal Vsel is made conductive or not, relative to said signal Vsel for substantially constant duration (pulse duration of Vsel) and the charge received by the capacitor C (hence the voltage at its terminals) depends therefore substantially on the level of the control voltage Vcom. One acts therefore on the lighting duration of the OLED while varying the voltage Vcom supplied to the capacitor C. The variation in the voltage Vcom therefore enables modulation encoding of the lighting pulse width of the OLED.

Preferably, the voltage Vcom remains substantially constant for the duration of the pulse Vsel (while neglecting the impact of the internal resistor of the source Vcom) and will be modified outside the pulses Vsel. The generator Vcom may be a digital/analogue converter with voltage output.

The choice of the values of Rf and C (own components or intrinsic to others as for example leakage current) will therefore be made notably relative to the frame duration and to the possible values of Vcom provided as well as that of the threshold of the control circuit so that there is a non-productive time (non lighting) within a frame for a OLED for which the maximum of Vcom has been sent to the capacitor during the pulse Vsel. One may also take into account the source resistor of the generator of Vcom and/or the leadthrough resistor of the selection circuit and/or of a possible additional circuit limiting the rise/fall time.

The time constant may be computed as follows:

The first step is the adjustment of the time constants of the assembly to the type of screen contemplated, in that instance a 1024×768 pixel display at a 75 Hz frequency gives a duration of the frame equal to 13.3 ms, and a selection time smaller than or equal to 17 μs.

The main characteristic time of the assembly is the constant RC, where C designates the storage capacitor of the control, and R is the leakage resistor at the terminals thereof. At the time scales considered, the transient phenomena in the transistors, of gate length fixed to 10 microns, are not perceptible. A solution with RC of the order of the microsecond is therefore requested.

More precisely, the point is to keep the OLED turned on for a duration close to half the frame duration. Indeed, in a screen-type application, liable to produce high dynamics display, it is essential not to maintain the control of display of a pixel throughout the frame duration, since this would cause, because of the visual remanence, blurred perception of any movement on the screen. At the frequency contemplated, the frame duration is roughly double that of the temporal perception of human vision system, whereof the generally accepted value is approx. 5 ms. To avoid superimposition of two frames, without modifying the refreshing frequency, therefore to limit the lighting of a pixel to approx. half the duration of the frame, and this for an OLED screen as well as for an LCD display (for which, the response time of the pixel itself should also be taken into account).

In the case of a purely voltage-control circuit, the discharge of the capacitor should turn off naturally the OLED before the end of the frame. An improvement in the dynamic visual qualities may even be expected thanks to the more regular variation of the lighting than in the case of the step-type control realised by an intensity/time driver. The point is to avoid the generation of too short an ignition cycle. Too quick discharge of the capacitor would have negative consequences on the display, and further involve higher peak intensity, in order to maintain the same average luminosity. An additional constraint is associated with the “staircase” effect: if the discharge is conversely too slow, the voltage at the terminals of the capacitor increases from one frame to another. Such behaviour corresponds to the storage phenomenon, which is specific to the voltage control par partial charging of the capacitor, and never occurs in the case of an intensity control, wherein the voltage at the terminals of the capacitor is forced independently for each frame relative to the current applied. It is therefore necessary, to maximise the discharge duration under the constraint of the stability of the assembly over a large number of frames for which the circuit is subjected systematically to a maximum lighting control, since the memory of the simulation computer does not enable in practice to exceed 500 cycles. A last constraint is of more concrete nature: given the size of a pixel, the capacitor is limited to a few pF maximum, and the more so because the selection duration does not enable to charge a greater capacitor.

Finally, the solution adopted is a constant RC equal to 6 ms, with R=kΩ, C=2 pF.

These values correspond to the best feasible time constant while preserving stability, and generate a significant current in the OLED for a duration close to half the frame. The current in the OLED is not cancelled out completely before the end of the frame, but the plotting of the voltage curve at the terminals of the OLED shows that said voltage falls again below the threshold voltage of the diode, estimated at approx. 4.9 V, after 6 ms at most. The current passing through the diode below this threshold may be considered very small in terms of lighting power with respect to the peak, and the OLED is in practice turned off before the end of the frame. This remanent current is not accompanied by a staircase-type behaviour that ought to be avoided, it appears however as soon as values slightly greater than the time constant are observed.

It should be understood that the examples of embodiment which have been given are purely illustrative and that other variations are considered within the framework of the invention. Notably, relative to the reversing type or not of the control circuit, in particular the control transistor M1, and to the type of selection circuit, in particular the transistor M2, the ignition of the OLED(s) may be obtained with a voltage greater than the threshold at the terminals of the capacitor or, conversely equal to zero and the charging/discharging of the capacitor may be obtained with a positive voltage Vₛₑₗ or, conversely, with a zero voltage. Finally, the expression ‘positive voltage’ is relative and according to the reference used and/or the components used, positive and negative voltages, possible only negative, with respect to the ground may be implemented. It is however preferable to use cells in an apparatus fitted with a display unit which relies on a single voltage, and, in particular that of its own power supply source which may be formed of throw-away batteries or of rechargeable batteries.

1-17. (canceled)

18. An electronic control cell for at least one organic light-emitting diode (OLED) of a pixel or segment of an active matrix display, the cell including at least:
one control circuit (61, 62) with a control input and operating as an electronic switch relative to a control signal arriving at a control line (5, 5′) on the control input and enabling to turn on the organic light emitting diode(s) (OLED) or not, relative to said control signal,
one capacitive storage circuit of the control signal with a capacitor (C) connected to the control line,
one selection circuit (41, 42) operating as an electronic switch relative to a selection signal (Vₛₑₗ) arriving at a selection line (3, 3′) and enabling electrical connection or insulation of the capacitive storage circuit with/from a control voltage (V_{com}) (2) relative to said selection signal, characterised in that the memorization duration of a perceptible turn on state is smaller than or equal to half a duration of a frame by discharging the capacitor through a resistor (Rf) parallel to the capacitor (C).

19. A cell according to claim 18, characterised in that the capacitor (C) is substantially an added-on capacitor.

20. A cell according to claim 18, characterised in that the capacitor (C) is substantially the capacitive portion of the intrinsic input impedance of the control circuit.

21. A cell according to claim 18, characterised in that the resistor (Rf) is substantially an added-on resistor.

22. A cell according to claim 18, characterised in that the resistor (Rf) is substantially the resistive portion of the intrinsic input impedance of the control circuit.

23. A cell according to claim 18, characterised in that the resistor (Rf) is substantially a leakage resistor of the capacitor (C).

24. A cell according to claim 18, characterised in that it includes a means reducing the maximum rise and/or fall rate of the voltage at the terminals of the capacitor (C) when the latter is connected to the control voltage (V_{com}).

25. A cell according to claim 18, characterised in that the control circuit is a field effect control transistor (M1) (61, 62).

26. A cell according to claim 18, characterised in that the selection circuit is a field effect control transistor (M2) (41, 42).

27. A cell according to claim 25, characterised in that the control circuit is a P-type field effect control transistor (M1) (61, 62) connected on the one hand directly to the positive pole (V_{dd}) of the power supply and on the other hand through the organic light emitting diode(s) (OLED) to the ground of the power supply, in that the selection circuit is a P-type field effect control transistor (M2) (41, 42) and in that the capacitor (C) and the resistor (Rf) in parallel return to the positive pole (V_{dd}).

28. A cell according to claim 25, characterised in that the control circuit is an N-type field effect control transistor (M1) (61, 62) connected on the one hand directly to the ground of the power supply and on the other hand through the organic light emitting diode(s) (OLED) to the positive pole (V_{dd}) of the power supply, in that the selection circuit is an N-type field effect control transistor (M2) (41, 42) and in that the capacitor (C) and the resistor (Rf) in parallel return to the ground.

29. A cell according to claim 25, characterised in that the transistors are thin-film transistors, so-called TFT.

30. An operating method of an electronic control cell for at least one organic light-emitting diode (OLED) of a pixel or segment of an active matrix display, the cell having at least:
one control circuit (61, 62) with a control input and operating as an electronic switch relative to a control signal arriving at a control line (5, 5′) on the control input and enabling to turn on the organic light emitting diode(s) (OLED) or not relative to said control signal,
one capacitive storage circuit of the control signal with a capacitor (C) connected to the control line,
one selection circuit (41, 42) operating as an electronic switch relative to a selection signal (Vₛₑₗ) arriving at a selection line (3, 3′) and enabling electrical connection or insulation of the capacitive storage circuit with/from a control voltage (V_{com}) relative to said selection signal, characterised in the implementation of a cell which is according to any of the previous claims and wherein the discharge of the capacitor is caused through a resistor (Rf) arranged parallel to the capacitor (C) in order to obtain a memorization duration of a perceptible turn on state smaller than or equal to half a duration of a frame.

31. An operating method according to claim 30, characterised in that the control signal is modulated in duration and/or in voltage level.

32. An operating method according to claim 30, characterised in that for turning the organic light emitting diode(s) (OLED) on, a selection pulse (Vₛₑₗ) is applied to the selection line of such a duration that at the end of the selection pulse the voltage at the terminals of the capacitor is a fraction of (V_{com}).

33. An operating method according to claim 30, characterised in that the control voltage (Vcom) is adjustable in amplitude, the conduction duration of the selection circuit (41, 42) by the selection signal being constant, in order to adjust the duration of the turned-on state so that it is smaller than the duration of the frame.

34. Display unit with organic light-emitting diodes (OLED) of pixels and/or segments implementing a set of electronic control cells of said diodes organised into a matrix, each pixel or segment being controllable individually by line×column multiplexing of the matrix, characterised in that the cells are according to claim 18.
